(19) United States
(12) Patent Application Publication
(10) Pub. No.: US 2006/0212281 A1
(43) Pub. Date: Sep. 21, 2006

(54) System and method for system-specific analysis of turbomachinery

(76) Inventors: Harry Kirk Mathews JR., Clifton Park, NY (US); John Harry Down, Lanesborough, MA (US)

Correspondence Address: Patrick S. Yoder;FLETCHER YODER, P.O. Box 692289, Houston, TX, 77269-2289, US

(21) Appl. No.: 11/085,901

(22) Filed: Mar. 21, 2005

(51) Int. Cl. G06G 7/48

(52) U.S. Cl. 703/7

(57) ABSTRACT

A method for system-specific analysis of an engine includes applying control inputs to the engine and an engine model and estimating outputs from the engine model based upon the control inputs. The method includes sensing outputs from the engine and analyzing residuals between estimated and sensed outputs. The method also includes customizing the engine model to reduce residuals for a particular engine and detecting the faults in the engine based upon the residuals for the particular engine.

### BACKGROUND

The invention relates generally to a system for performing a system-specific analysis of turbomachinery such as detecting and isolating faults in turbomachinery and, more particularly, to a system for detecting and isolating faults in an aircraft engine.

Various types of turbomachinery are known and are generally in use in a range of applications, such as jet engines, industrial gas turbines, steam turbines and so forth. Typically, the components of the turbomachinery may be subjected to general wear and tear during their lifetime. In addition, the components may be exposed to abnormal conditions while in operation. As a result, the components of the turbomachinery can deteriorate, fail and lead to faults and inefficient operation of the turbomachinery. Consequently, it may be desirable to detect and isolate such faults in the engine for tracking engine health to ensure efficient operation of the engine.

Many specific techniques have been developed for detecting faults in the components of the engines and other systems. For example, in some systems data related to specific engine parameters is collected over a period of time and such data is analyzed and used for predicting engine outputs. Typically, models of jet engine performance are used to predict engine outputs based upon the collected input data. In addition, sensors are employed for measuring engine outputs for various components of the engine. Further, the differences between the predicted engine outputs and measured engine outputs are used for detecting and isolating faults in the engine.

In general, the engine model is based upon a sample of fleet of engines and there may be a significant variation in such model from one engine to another in the fleet of engines. In addition, there is variation in the input data across the fleet of engines. Such variation in the input data across the fleet of engines and the model errors causes scatter in the differences between the predicted and measured engine outputs that limits the performance of fault detection and isolation of faults.

Accordingly, it would be desirable to develop a system to detect and isolate faults in turbomachinery in a more efficient manner. More specifically, it would be desirable to have an efficient fault detection system for an aircraft engine that reduces the scatter in the engine outputs across a fleet of engines and thereby provides efficient fault detection and isolation along with a relatively accurate estimate of an engine component health for a particular engine over a period of time.

### BRIEF DESCRIPTION

Briefly, in accordance with one aspect of the present invention a method for system-specific analysis of an engine includes applying control inputs to the engine and an engine model and estimating outputs from the engine model based upon the control inputs. The method includes sensing outputs from the engine and analyzing residuals between estimated and sensed outputs. The method also includes customizing the engine model to reduce residuals for a particular engine and detecting the faults in the engine based upon the residuals for the particular engine. Computer-readable medium that afford functionality of the type defined by this method is also provided by the present technique.

In accordance with another aspect of the present invention a system for detecting faults in an engine includes an engine model configured to receive control inputs corresponding to the engine control inputs and sensed inputs and to estimate outputs based upon the control inputs and the sensed inputs. The system also includes a plurality of sensors configured to sense outputs from the engine and an estimator configured to customize the engine model to reduce residuals between the estimated and sensed outputs.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a fault detection system for an engine in accordance with aspects of the present technique;

FIG. 2 is a diagrammatical representation of the fault detection system of FIG. 1 having an estimator for customizing the engine model to match the engine in accordance with aspects of the present technique;

FIG. 3 is a block diagram representing a discrete extended Kalman filter employed in the fault detection system of FIG. 2 in accordance with aspects of the present technique;

FIG. 4 is a block diagram representing the steps for fault detection and isolation in an engine by the fault detection system of FIG. 2 in accordance with aspects of the present technique;

FIG. 5 is a diagrammatical representation of training windows over a period of time for customizing the engine model by the fault detection system of FIG. 2 in accordance with aspects of the present technique;

FIG. 6 is a diagrammatical representation of a multiple model fault detection system for detecting faults in an engine in accordance with aspects of the present technique;

FIG. 7 is a flow chart illustrating a process for detecting and isolating faults by the multiple model fault detection system of FIG. 6 in accordance with aspects of the present technique; and

FIG. 8 is a block diagram representing on-site and remote locations for the fault detection system of FIG. 2 in accordance with aspects of the present technique.

### DETAILED DESCRIPTION

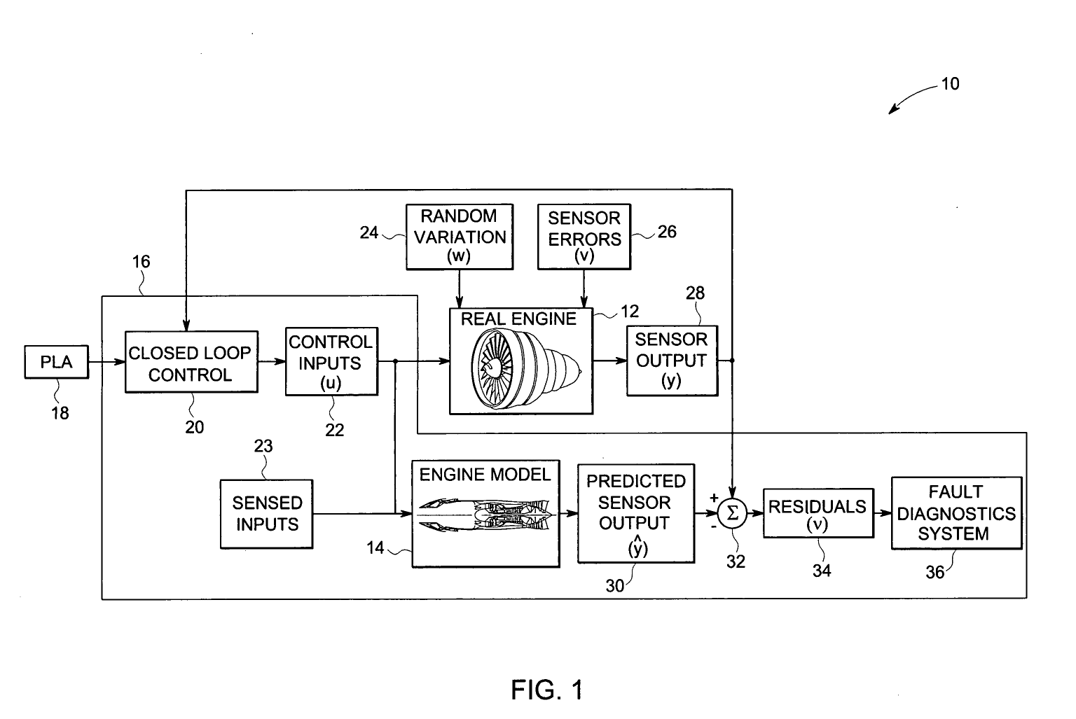

As discussed in detail below, embodiments of the present technique function to detect and isolate faults in turbomachinery such as an aircraft engine, an industrial gas turbine and a steam turbine. Turning now to drawings and referring first to FIG. 1 a fault detection system 10 for an engine 12 is illustrated. The fault detection system 10 includes an engine model 14 configured to receive control inputs corresponding to engine control inputs. Further, engine model 14 is configured to estimate outputs from the engine 12. In the illustrated embodiment, the engine 12 receives the control inputs via a Full Authority Digital Engine Control module (FADEC) 16 and such control inputs depend upon a throttle setting of the engine 12. Further, a power lever angle module (PLA) 18 is employed to provide a measurement of the throttle setting to the engine 12. The throttle setting for the engine 12 may be controlled to control parameters such as a desired engine thrust, a target air speed and so forth for all flight regimes of the engine 12 from takeoff to touchdown. As will be appreciated by those skilled in the art other control modules or systems may be employed for controlling the engine settings based upon the control inputs.

In this embodiment, the inputs from the PLA 18 are processed through a closed loop control 20 to generate control inputs 22 (u) for the engine 12 and the engine model 14. In one embodiment, the engine model 14 includes a physics-based model. In another embodiment, the engine model 14 includes an empirical model. Further, the engine model 14 may include a steady state model. Alternatively, the engine model 14 may include a transient model. In the illustrated embodiment, the control inputs 22 may include, but are necessarily not limited to, a fuel flow, an active clearance control, variable geometry, power extraction and combinations thereof for components of the engine 12. Typically, the components of the engine 12 include a fan, a booster, a high-pressure compressor, a low-pressure compressor, a high-pressure turbine, a low-pressure turbine and a combustor, among others. Other or different components and parameters may, of course, be monitored and controlled by the present techniques, depending upon the aircraft type, its equipment, and the control regimes envisaged. In addition, the engine model 14 may receive sensed inputs 23 such as, but not necessarily limited to, temperature, pressure, altitude, Mach number, or combinations thereof. Further, as will be appreciated by one skilled in the art such sensed inputs 23 will typically be experienced by the engine 12 in operation. Of course, these sensed inputs 23 are considered inputs for the engine model 14.

In the illustrated embodiment, the components of the engine 12 operate based upon the control inputs 22. Further, a plurality of sensors (not shown) may be coupled to each of the components of the engine 12 for sensing outputs from the engine 12. In certain embodiments, the sensed outputs from engine may include noise components due to factors such as random variation 24 (w) and sensor errors 26 (v) for the plurality of sensors coupled to the components of the engine 12. In operation, the plurality of sensors measure sensed outputs 28 (y) of the components. Examples of sensed outputs 28 include temperature, pressure, rotor speed, efficiency, flow capacity, inter-component temperature and so forth.

In a presently contemplated configuration, the engine model 14 generates predicted sensor outputs 30 (ŷ) based upon the control inputs 22. The predicted sensor outputs 30 from the engine model 14 do not include any noise components due to the random variation 24 and the sensor errors 26. The sensed outputs 28 from the plurality of sensors are combined and compared with the predicted senor outputs 30 as represented by reference numeral 32 to estimate residuals 34 (v). Further, the estimated residuals 34 may be analyzed to detect and isolate faults in the engine 12 by comparing the estimated residuals 34 with fault signatures via a fault diagnostics system 36 that will be described below. In a presently contemplated configuration the fault diagnostics system 36 is a part of the FADEC 16. However, those skilled in the art will appreciate that the fault diagnostics system 36 may be isolated from the FADEC 16 or other control systems. This is particularly true in aircraft where no FADEC 16 is present. In certain embodiments, the fault diagnostics system 36 may be partitioned within the FADEC 16 from the other control modules. In one embodiment, the estimated residuals 34 may be analyzed in real time on-wing. Alternatively, the estimated residuals 34 may be analyzed at a diagnostic location on ground, either in real time, near real time, or at a later time.

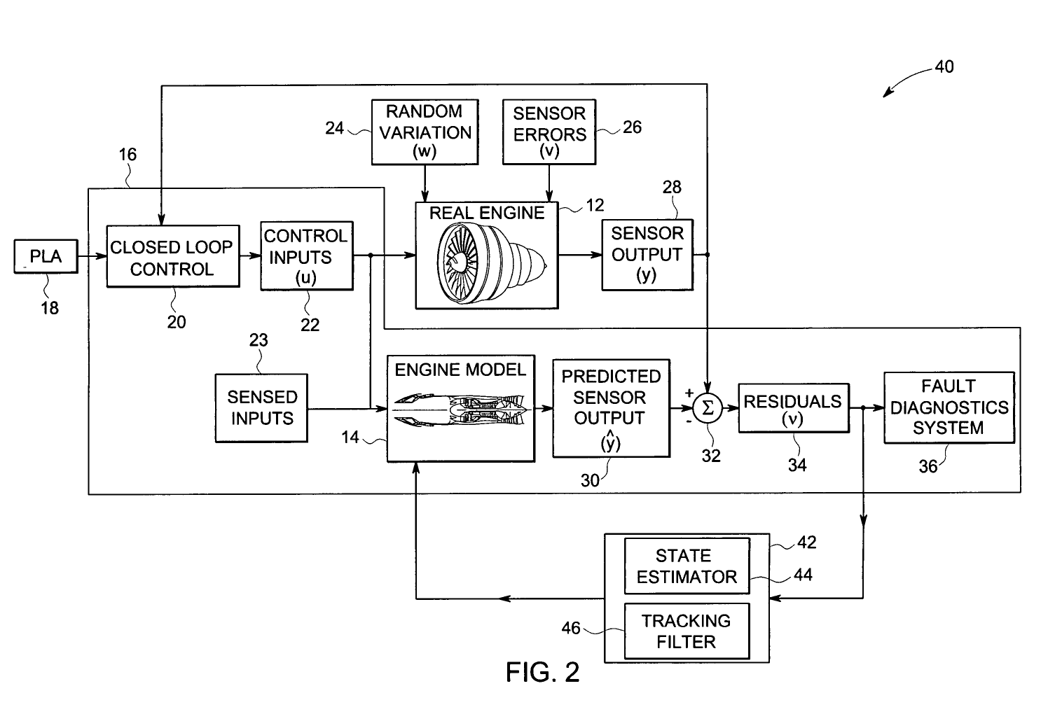

In accordance with the present techniques, the engine model 14 may be customized to reduce residuals 34 between the sensed outputs 28 and the predicted sensor outputs 30 for the particular engine 12. Further, the residuals 34 for a customized engine model 14 may function to reduce model errors and errors due to noise such as random variation 24 and sensor errors 26, thereby providing a substantially accurate detection of faults in the engine 12. It should be noted that it is the ability to correct for model errors that permits system-specific customization of the engine model 14. The engine model 14 may be customized to match the particular engine 12 by coupling an estimator to the engine model 14 that will be described below with reference to FIG. 2.

FIG. 2 illustrates an exemplary configuration 40 of the fault detection system of FIG. 1. In a presently contemplated configuration an estimator 42 is coupled to the engine model 14 for customizing the engine model 14 to match the engine 12. In this embodiment, the estimator 42 is configured to customize the engine model 14 to reduce residuals 34 between the predicted outputs 30 and the sensed outputs 28. In this embodiment, the estimator 42 includes a state estimator 44 and a tracking filter 46. In the foregoing discussion, reference is made to the tracking filter 46 as function of the more general estimator 42. As will be appreciated by one skilled in the art “tracking filter” may be referred to as different terms in different contexts. The state estimator 44 is configured to predict a state of the engine 12 at any point in time. Further, the tracking filter 46 is configured to estimate parameters for the engine model 14 based upon an observer for reducing the residuals 34. In another embodiment, the function of state estimator and tracking filter are combined into a single estimator. In the following discussion it is understood that “tracking filter” refers to the function of the combined estimator or the “tracking filter” by itself. In this embodiment, the tracking filter 46 includes an extended Kalman filter. However, other types of filters may be employed for reducing the residuals 34 between the sensed outputs 28 and the predicted outputs 30. Moreover, the extended Kalman filter 46 may be implemented as a batch process for steady state engine models 14. Alternatively, the extended Kalman filter 46 may be implemented as a recursive process for transient engine models 14.

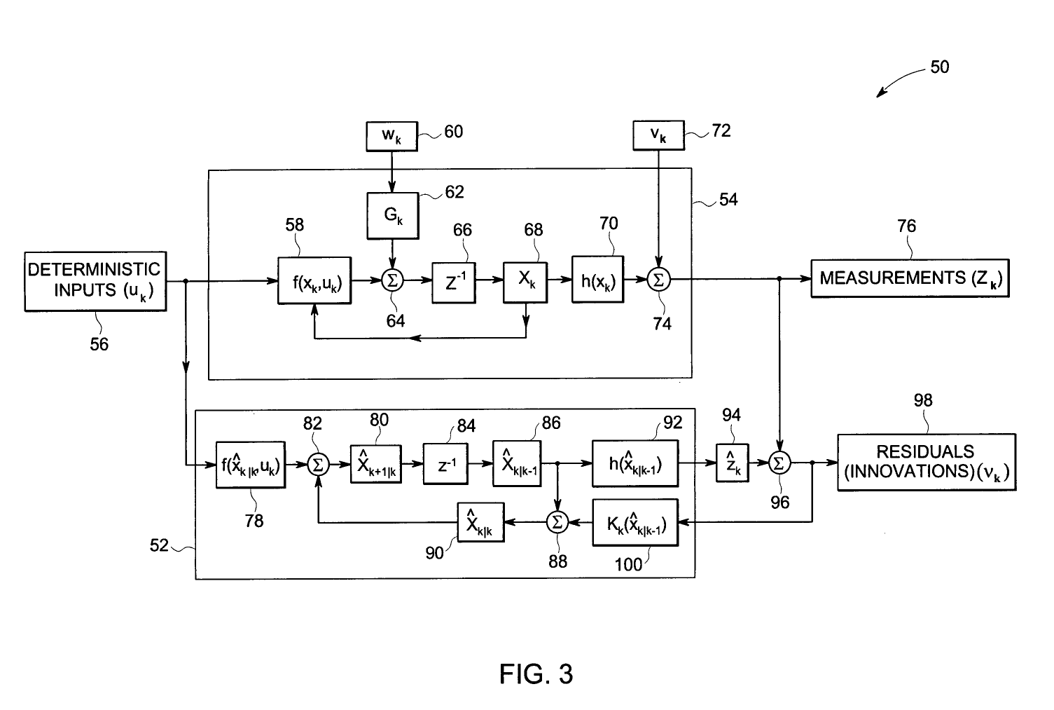

In operation, the estimated parameters from the estimator 42 are applied to the engine model 14 to update the parameters of the engine model 14 for reducing the residuals 34. It should be noted that in a presently contemplated embodiment, the parameters of the engine model 14 are updated at a bandwidth sufficiently fast to track changes in the engine 12 and sufficiently slow to avoid masking faults occurring in the engine 12 to avoid the engine model 14 adapting to faults in the engine 12 that are otherwise required to be detected for an efficient operation of the engine 12 (i.e., customizing the model to undesired conditions). Advantageously, the residuals 34 from the customized engine model 14 may be utilized for detecting and isolating the faults in the engine 12 via the fault diagnostics system 36. In this embodiment, the tracking filter 46 analyzes the residuals (sometimes referred to as “innovations”) 34 to estimate the engine parameters that will be described below with reference to FIG. 3.

FIG. 3 is a block diagram representing an exemplary fault detection system 50 having a discrete extended Kalman filter 52 coupled to a system 54. In this embodiment, the system 54 includes an engine. Although not limited to any particular model, the engine 54 can be modeled as a mathematical representation illustrated in FIG. 3. In operation, deterministic inputs 56 (uₖ) are provided to the system 54 and the filter 52 at a current time step k. In the illustrated embodiment, the state of the system 54 is mathematically determined by a dynamic function 58 (f(xₖ, uₖ)). In addition, the dynamic function 58 receives process noise 60 (wₖ) that is incorporated into the dynamic function 58 via a filter gain 62 (Gₖ) to generate an updated state 64. Further, a delay operator 66 (z⁻¹) may be employed to include any delay between subsequent time steps and to estimate a state 68 (Xₖ) of the system 54. In certain embodiments, this estimated state 68 may be applied to the dynamic function 58 to update the dynamic function 58.

In the illustrated mathematical representation, a non-linear function 70 (h(xₖ)) relates the estimated state 68 of the system to measurements from the system 54. In this embodiment, measurement noise 72 (vₖ) such as due to sensor errors may be incorporated into the function 70 of the system 54 as represented by reference numeral 74. As a result, the system 54 generates outputs or measurements 76 (Zₖ) at the given time step k that may be utilized by the filter 52 for estimation of residuals as will be described below.

As described above, the filter 52 receives the deterministic inputs 56 that are employed by the system 54 for generating the measurements 76. In the illustrated embodiment, the deterministic inputs 56 are applied to a function 78 (f(\hat{x}_{k|k}, uₖ)) for generating an a priori estimate of the state of the system 54 for the next time step from a previous time step k as represented by reference numerals 80 and 82. Again, a delay operator 84 (z⁻¹) may be employed to incorporate any changes to the state due to any delays between subsequent time steps to generate an updated estimate 86 (\hat{X}_{k|k-1}). Such updates may be incorporated into the existing state 80 as computed by summers 82 and 88. Further, a non-linear function 92 (h(\hat{x}_{k|k-1})) may utilize the updated estimate 86 to estimate predicted measurements 94 (\hat{z}ₖ).

In a presently contemplated configuration, the measurements 76 from the system 54 are collated and compared with the predicted outputs 94 as represented by reference numeral 96 to generate residuals (innovations) 98 (vₖ). Moreover, the generated residuals 98 are multiplied by an observer gain 100 (Kₖ(\hat{x}_{k|k-1})) that may be employed to reduce the residuals 96 to customize the existing state 86. In this embodiment, the observer gain 100 includes a Kalman gain Kₖ that is given by the following equations:
Kₖ=P_{k|k-1}Hₖ^{T}(HₖP_{k|k-1}Hₖ^{T}+Rₖ) (1)
P_{k|-1}=AₖP_{k-1|k-1}Aₖ^{T}+GₖQₖGₖ^{T} (2)
P_{k|k}=(I−KₖHₖ)P_{k|k-1} (3)

where:
P_{k|j} is a state estimate error covariance at time k given measurements up to time j;
Qₖ is the process noise covariance at time k;
Rₖ is the measurement noise variance at time k;
Hₖ is the Jacobian matrix from linearization of the non linear function h(\hat{x}_{k|k-1}) at time k; and
Aₖ is the Jacobian matrix from linearization of the function f(\hat{x}_{k|k}, uₖ)

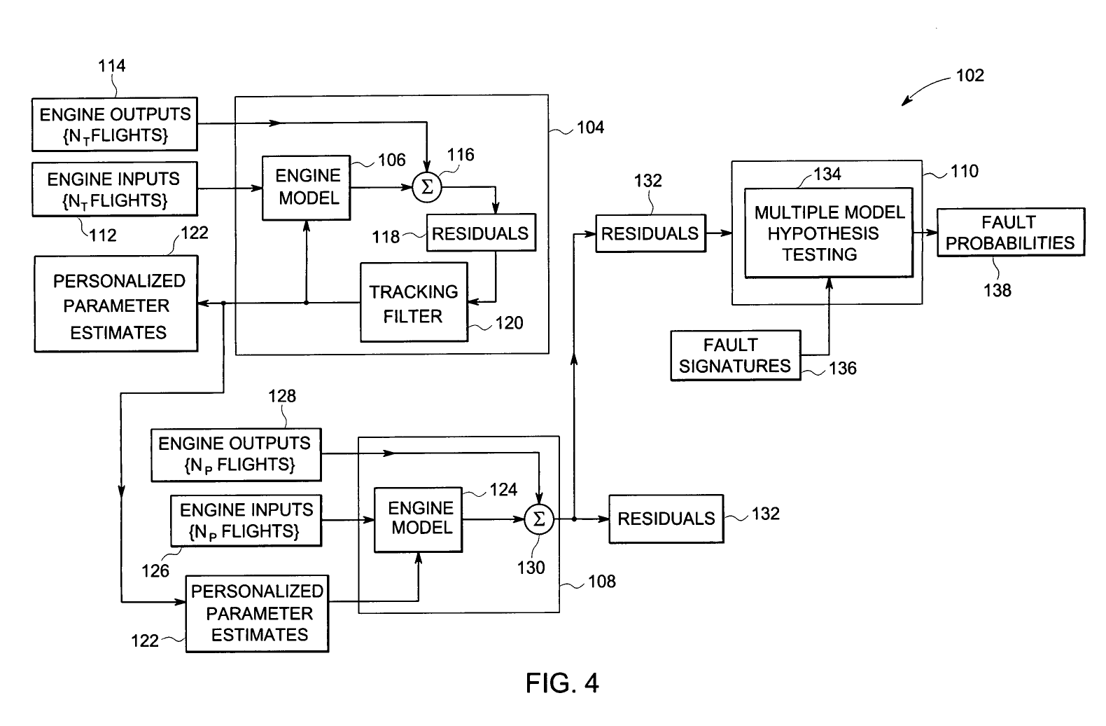

Referring now to FIG. 4, an exemplary process 102 of operation of the fault detection system of FIG. 2 is illustrated. In the illustrated embodiment, the process 102 includes estimation of parameters 104 for an engine model 106, prediction of residuals 108 and diagnostics of engine faults 110. In operation, the engine model 106 receives engine inputs 112 from a pre-determined number of training flights N_{T}. Typically, the engine inputs 112 include engine control inputs such as fuel flow, an active clearance control, variable geometry, power extraction, or combinations thereof for components of the engine. In addition, the engine inputs 112 also include sensed inputs such as temperature, pressure, altitude, Mach number and combinations thereof. Further, the engine model 106 estimates outputs based upon the engine inputs 112. The estimated outputs from the engine model 106 are then collated from the pre-determined number of training flights N_{T}. Subsequently, the generated outputs from the engine model 106 are compared with the sensed engine outputs 114 as represented by reference numeral 116. As a result, residuals 118 are calculated based upon the estimated outputs and the sensed engine outputs 114.

In the illustrated embodiment, the residuals 118 are provided to a tracking filter 120 for generating “personalized” (i.e., system-specific) parameter estimates 122 for the engine, that is, estimates that are adapted to the particular aircraft and equipment rather than for a generic fleet of aircraft and equipment. In this embodiment, the tracking filter 120 includes an extended Kalman filter. The tracking filter 120 analyzes the residuals 118 and generates the personalized parameter estimates 122 for reducing the residuals 118 between the generated outputs and the sensed engine outputs 114.

The estimated personalized parameters 122 from the engine model 106 are applied to an engine model 124 for prediction of residuals. In the illustrated embodiment, the parameters of the engine model 124 are updated based upon the personalized parameters 122 to match the current state of the engine model 124 with the current state of the engine model 106. Moreover, the engine model 124 receives engine inputs 126 from a pre-determined number of prediction flights N_{P}. Again, the engine inputs 126 may include engine control inputs and sensed inputs as described earlier. In this embodiment, the engine model 124 generates outputs based upon the engine inputs 126. Examples of generated outputs include temperature, pressure, rotor speed, efficiency, flow capacity, inter-component temperature and so forth.

Additionally, the engine model 124 receives engine sensed outputs 128 from the pre-determined number of prediction flights N_{P}. Subsequently, the generated outputs from the engine model 124 are collated and compared with the engine sensed outputs 128 as represented by reference numeral 130. As a result, residuals 132 for the engine model 124 are estimated based upon the generated outputs and the engine sensed outputs 128. Advantageously, the residuals 132 from the personalized engine model 124 may be employed for diagnosing the faults in the engine via a multiple model hypothesis test 134.

In a presently contemplated configuration, the residuals 132 from the personalized engine model 124 are then compared with a set of faults or fault signatures 136 via the multiple model hypothesis test 134 for detecting and isolating the faults in the engine. In certain embodiments, fault probabilities 138 may be computed by the multiple model hypothesis test 134. In certain other embodiments, a severity estimate for the detected faults may be generated. In such embodiments, the severity estimate is calculated based upon the fault probabilities 138 and a magnitude of the fault signatures. Further, the estimated parameters 122 may be employed for generating a trend over time for detecting abnormal deterioration of the components of the engine.

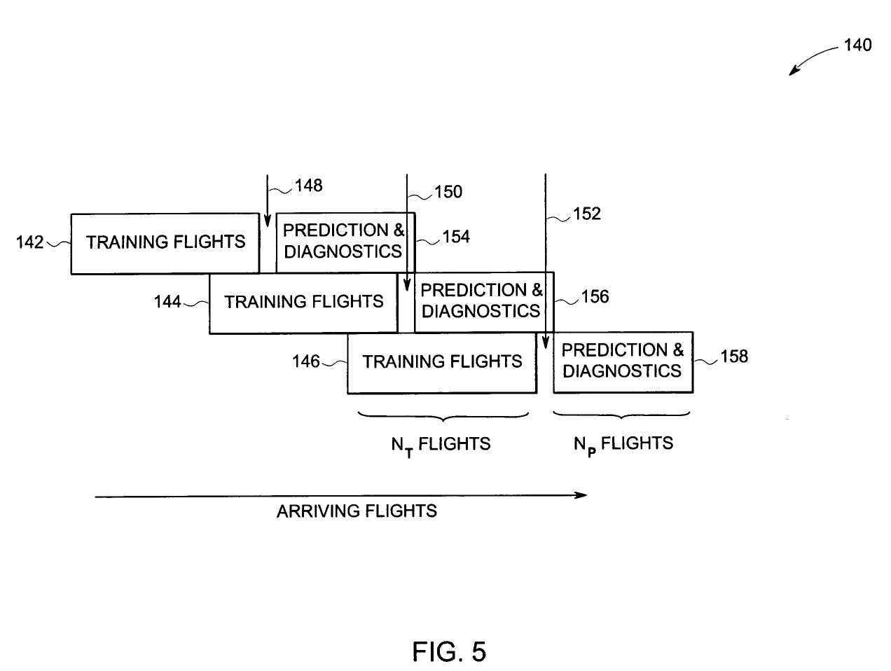

As described above, the personalized parameter estimates 122 may be generated from the pre-determined number of training flights N_{T} and the residuals 132 from the engine model 124 may be obtained from the pre-determined number of prediction flights N_{P}. FIG. 5 is a diagrammatical representation of training and prediction windows 140 over a period of time for customizing the engine model by the fault detection system of FIG. 2. By way of example, the windows for the training flights N_{T} are represented by reference numerals 142, 144 and 146. In the illustrated embodiment, a new set of personalized parameters is estimated at the end of each of the training windows 142, 144 and 146. Further, each set of the personalized parameters from the training windows 142, 144 and 146 are applied to the engine model at the end of each of the training windows 142, 144 and 146 for customizing the engine model to match a particular engine as represented by reference numerals 148-152.

In the illustrated embodiment, the personalized parameters from the training windows 142, 144 and 146 are utilized by the engine model for predicting engine outputs in the prediction windows as represented by reference numerals 154, 156 and 158. In addition, for each of the prediction windows 154, 156 and 158 the predicted engine outputs are compared with sensed outputs from the engine to generate residuals. As noted above, the residuals may be further utilized for detecting and isolating faults in the engine.

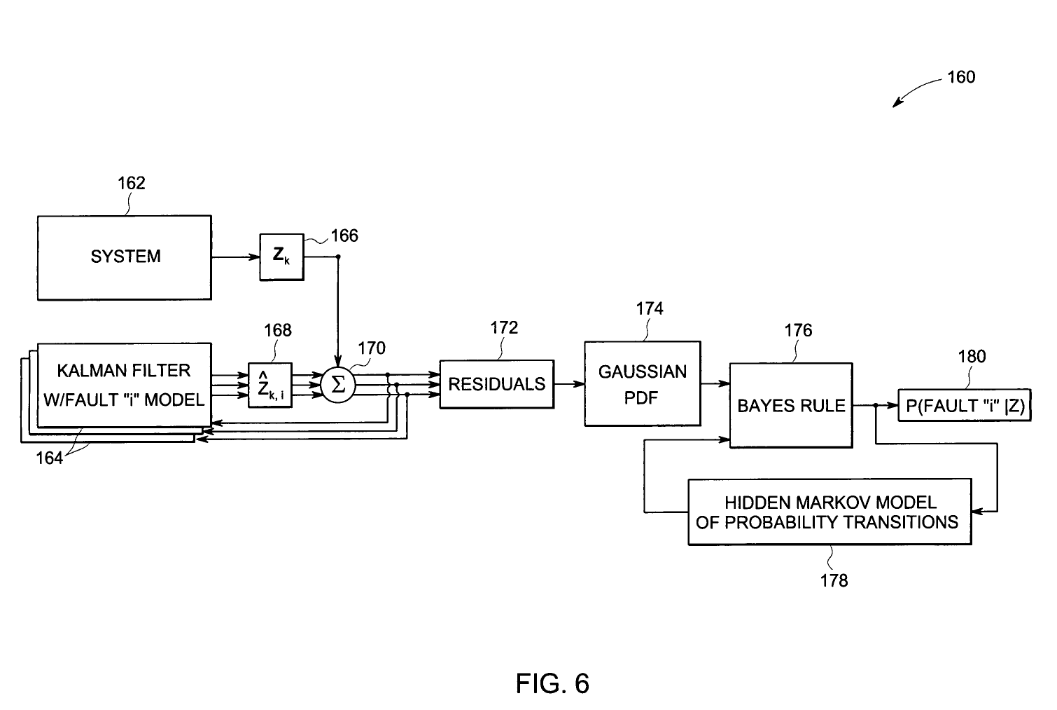

FIG. 6 illustrates a diagrammatical representation of an exemplary multiple model fault detection system 160 for detecting faults in a system 162. In this embodiment, the system 162 includes an engine. In the illustrated embodiment, the multiple model fault detection system 160 includes a plurality of Kalman filters 164 and each of the Kalman filters 164 employs a specific fault model. In the illustrated embodiment, measurements 166 (Zₖ) from the system 162 are collated and compared with the estimated outputs 168 (\hat{Z}_{k,i}) from the plurality of Kalman filters 164 as represented by reference numeral 170. As a result, residuals 172 between the measurements 166 and the estimated outputs 168 are generated that may be utilized for detecting and isolating faults.

In the illustrated embodiment, the residuals 172 generated from the plurality of Kalman filters 164 are applied to a probability density function such as a Gaussian probability density function 174 for detecting faults based upon a likelihood of the residuals 172. In certain embodiments, Bayes rule 176 along with a hidden Markov model (HMM) 178 may be employed for determining fault probabilities 180 (P(fault′i′|z)) from the residuals 172. In the illustrated embodiment, a fault in the system 162 may be detected based upon the fault probabilities 180 and pre-determined thresholds.

In this embodiment, the fault probability 180 for each of the faults may be estimated between time updates by employing a probability transition matrix C_{P}. The probability of i^{th} fault at a given time k is estimated based upon the measurements up to time k−1 and is given by the following equation:
P(fᵢ|tₖ,vₖ₋₁,vₖ₋₂, . . . )=C_{P}·P(fᵢ|tₖ₋₁,vₖ₋₁,vₖ₋₂, . . . ) (4)

where:
C_{P}(i, j) is the probability of transition from fault ‘j’ to fault ‘i’; and
vₖ is the innovation or residual at the given time k.

Further, a likelihood of the residual vₖ for each fault fᵢ may be estimated by using a Gaussian distribution as given by the following equation:

$$p ( {v}_{k} \vert {t}_{k} , {f}_{i} , {v}_{k - 1} , {v}_{k - 2} , … ) = \frac{1}{\sqrt{{( 2 π )}^{m} \vert {H}_{k} {P}_{k \vert k - 1} {H}_{k} + {R}_{k}}} {ⅇ}^{- \frac{1}{2} {{v}_{k}^{T} ( {H}_{k} {P}_{k \vert k - 1} {H}_{k} + {R}_{k} )}^{- 1} \cdot {v}_{k}} \qquad ( 5 )$$

where:
P_{k|j} is a state estimate error covariance at time k given measurements up to time j;
Rₖ is the measurement noise variance at time k and;
Hₖ is the Jacobian matrix for linearization of the non linear function h(\hat{x}_{k|k-1}) at time k.
In addition, the probability of each fault is determined by employing Bayes rule. The probability of a i^{th} fault at a time k is estimated based upon all measurements up to time k and is given by the following equation:

$$P ( {f}_{i} \vert {t}_{k} , {v}_{k - 1} , {v}_{k - 2} , … ) = \frac{p ( {v}_{k} \vert {t}_{k} , {f}_{i} , {v}_{k - 1} , {v}_{k - 2} , … ) \cdot P ( {f}_{i} \vert {t}_{k} , {v}_{k - 1} , {v}_{k - 2} , … )}{{\sum }_{j = 1}^{n} p ( {v}_{k} \vert {t}_{k} , {f}_{i} , {v}_{k - 1} , {v}_{k - 2} , … ) \cdot P ( {f}_{i} \vert {t}_{k} , {v}_{k - 1} , {v}_{k - 2} , … )} \qquad ( 6 )$$

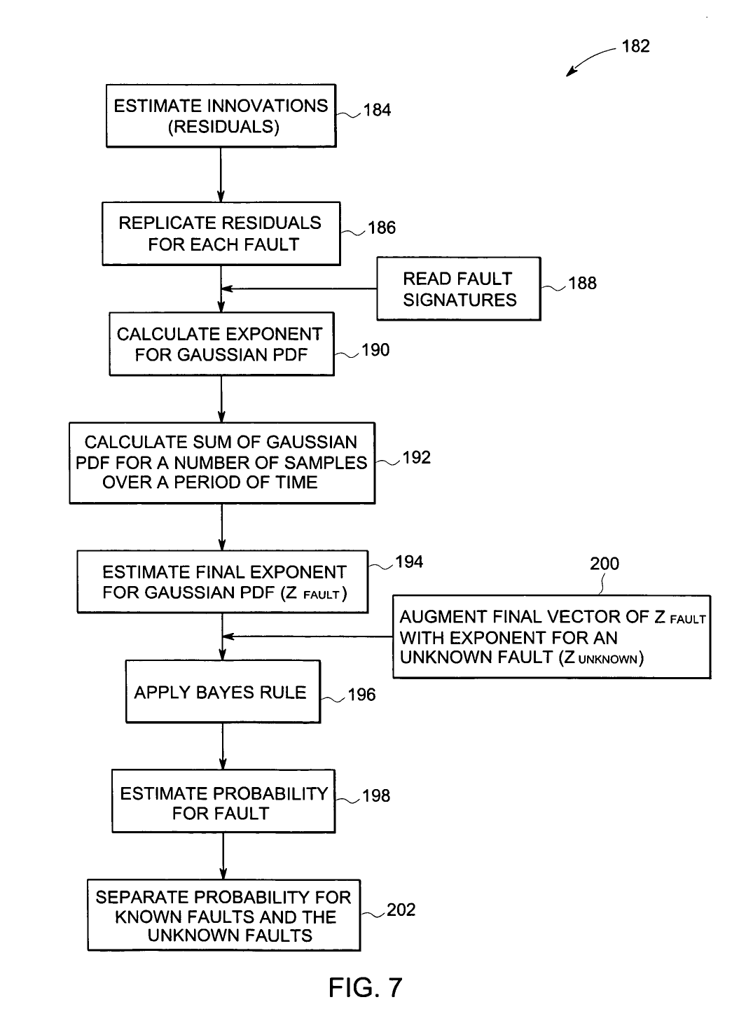

FIG. 7 illustrates an exemplary process 182 for detecting and isolating faults by the multiple model fault detection system of FIG. 6. The process 182 begins with estimating innovations or residuals between the estimated and sensed outputs as represent by step 184. Next, at step 186 residuals associated with each fault are replicated. The replication step includes transforming the residuals into a matrix structure similar to that of the fault signatures. At step 188, a set of faults or fault signatures for the engine model are read into the system. Further, at step 190 the exponent for the Gaussian probability density function (PDF) (see equation 5) for each fault is estimated for detecting the faults based upon a likelihood of the residuals.

Next, at step 192 a sum of Gaussian PDF is calculated for a number of samples over a period of time to estimate a final exponent (Z_{fault}) for the number of samples as represented by step 194. At step 196 Bayes rule may be applied to the residuals to determine fault probabilities for each of the fault as shown at step 198. In certain embodiments, the final vector of exponent (Z_{fault}) may be augmented with an exponent for an unknown fault (Z_{unknown}) to detect and isolate a fault other than the set of faults (step 200). In one embodiment, the unknown fault may function as a threshold for a detected fault that does not match any of the fault signatures. Thus, the augmentation of the final exponent with the unknown fault facilitates substantially accurate prediction of the fault probabilities. Further, the probability of occurrence of the unknown fault may be separated from the set of faults as represented by step 202.

As noted above, the present technique detects and isolates faults in the engine by analyzing the residuals between outputs estimated from an engine model and outputs measured from the engine. It should be noted that the estimated residuals may be analyzed in real-time on wing. Alternatively, the estimated residuals may be analyzed on a diagnostic location on ground. That is, parameter data, either raw or processed, may be transmitted from the aircraft to a ground location for computation of the derived parameters and residuals, and for analysis of the residuals as described above. This may be done in real-time, near real time, or even at a later time (e.g., following a flight).

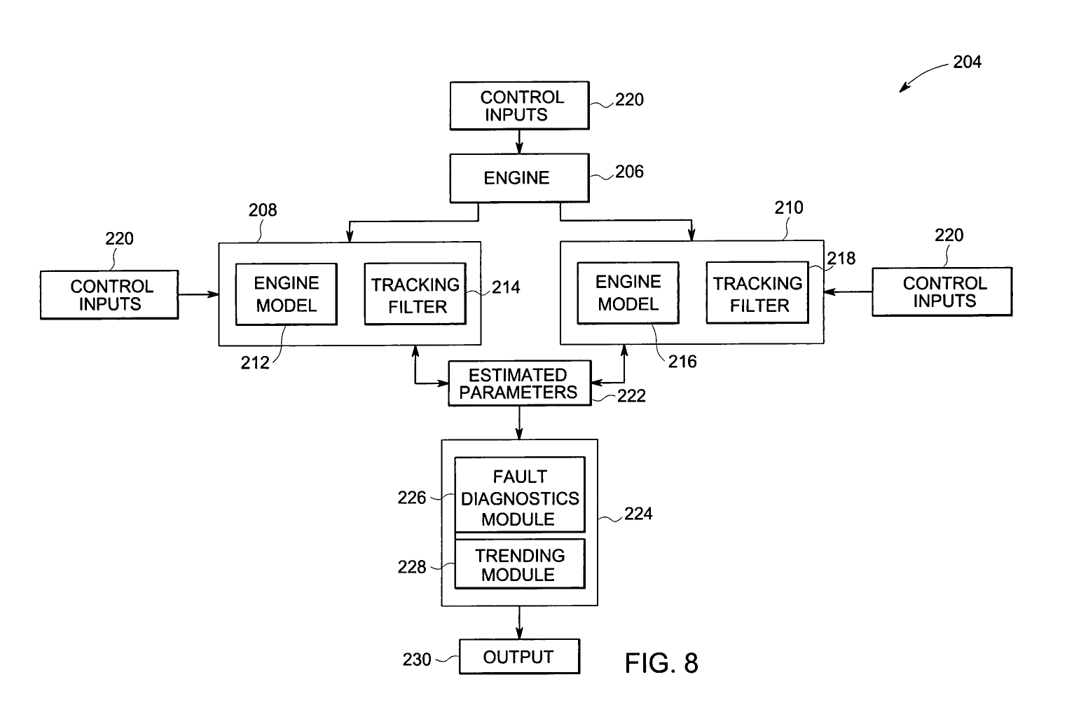

FIG. 8 illustrates an exemplary fault detection system 204 for an engine 206 having on-wing and remote diagnostic units 208 and 210 for the fault detection system of FIG. 2. In the presently contemplated configuration, the on-wing diagnostic unit 208 includes an engine model 212 and a tracking filter 214. Similarly, the remote diagnostic unit 210 may include an engine model 216 and a tracking filter 218. As described above the engine models 212 and 216 may include a steady state model or a transient model. Further, the engine models 212 and 216 may include a physics based model or an empirical model, among others.

In operation, the engine 206 receives input control inputs 220. Examples of such inputs include fuel flow, an active clearance control, variable geometry, power extraction, or combinations thereof for components of the engine 206. In addition, the control inputs 220 also include sensed inputs such as temperature, pressure, altitude, Mach number and combinations thereof. Further, the control inputs 220 are applied to the engine models 212 and 216 for the on-wing and the remote diagnostics units 208 and 210 for predicting outputs from the engine models 212 and 216 based upon the control inputs 220. The tracking filters 214 and 218 are configured to analyze the residuals between the predicted and sensed outputs from the engine 206 for generating personalized parameter estimates 222 for the particular engine 206.

In one embodiment, the engine model 212 of the on-wing diagnostic unit 208 may be employed for estimating outputs. Subsequently, the tracking filter 214 of the on-wing diagnostic unit may be employed for analyzing the residuals and for generating personalized parameter estimates 222. In another embodiment, the engine model 212 of the on-wing diagnostic unit 208 may be employed for estimating outputs and the estimated residuals between the estimated outputs and sensed outputs may be analyzed at the remote diagnostic location 210 via the tracking filter 218. Thus, a combination of the engine models 212 and 216 along with the tracking filters 214 and 218 may be employed for analyzing the residuals thereby facilitating the detection of faults in the engine 206.

The estimated personalized parameters 222 for the particular engine 206 are utilized for fault detection and isolation through a fault detection system 224. The fault detection system 224 analyzes the residuals and detects faults in the engine 206 by comparing the residuals with fault signatures via a fault detection module. Additionally, based upon the estimated personalized parameters 222 a trend of deterioration of the engine 206 may be generated via a trending module 228 to detect any abnormal deterioration of the components of the engine 206. In this embodiment, the parameters corresponding to the faults detected by the fault detection system 224 may be made available to a user through an output 230. Examples of such parameters include fault probabilities and severity estimates for the detected faults.

The various aspects of the technique described hereinabove have utility in turbomachinery for example, an aircraft engine, an industrial gas turbine and a steam turbine. As will be appreciated by those skilled in the art, the present technique provides an efficient fault detection system for an aircraft engine that personalizes an engine model to match the individual engine. In addition, the technique provides a mechanism to reduce the scatter in the engine outputs across a fleet of engines and thereby provides a relatively accurate estimate of an engine component health for the particular engine over a period of time.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for system-specific analysis of an engine, comprising:
applying control inputs to the engine and an engine model;
estimating outputs from the engine model based upon the control inputs;
sensing outputs from the engine;
analyzing residuals between estimated and sensed outputs; and
customizing the engine model to reduce residuals for a particular engine.

2. The method of claim 1, further comprising detecting the faults in the engine based upon the residuals for the particular engine.

3. The method of claim 1, wherein estimating the outputs from the engine model comprises estimating the outputs through a physics based model, or a steady state model, or a transient model, or an empirical model, or combinations thereof.

4. The method of claim 1, wherein analyzing the residuals comprising analyzing the residuals in real time on-wing.

5. The method of claim 1, wherein analyzing the residuals comprising analyzing the residuals at a diagnostic location on ground.

6. The method of claim 1, wherein customizing the engine model comprises estimating parameters via an extended Kalman filter and applying the estimated parameters to the engine model.

7. The method of claim 6, wherein applying the estimated parameters to the engine model comprises updating the parameters of the engine model at a bandwidth sufficiently fast to track changes in the engine and sufficiently slow to avoid masking faults occurring in the engine.

8. The method of claim 6, wherein customizing the engine model comprises implementing the extended Kalman filter as a batch process for steady state engine models.

9. The method of claim 6, wherein customizing the engine model comprises implementing the extended Kalman filter as a recursive process for transient engine models.

10. The method of claim 6, comprising deriving an observer gain from the extended Kalman filter and using the derived observer gain to estimate the parameters for the engine model.

11. The method of claim 1, further comprising isolating the faults in the engine from a set of faults or fault signatures via a multiple model hypothesis test based upon the residuals for the particular engine.

12. The method of claim 11, wherein isolating the faults comprises identifying faults that are different from the set of faults or the fault signatures by augmenting the set of faults with an additional fault.

13. The method of claim 11, further comprising computing a probability of the faults in the engine via the multiple model hypothesis test.

14. The method of claim 13, further comprising determining a severity estimate for the identified faults based upon the probability of faults and a magnitude of the fault signatures.

15. The method of claim 1, further comprising generating a trend of deterioration of the engine on a component-by-component basis based upon the estimated parameters for the engine.

16. A system for detecting faults in an engine, comprising:
an engine model configured to receive control inputs corresponding to the engine control inputs and sensed inputs and to estimate outputs based upon the control inputs and the sensed inputs;
a plurality of sensors configured to sense outputs from the engine; and
an estimator configured to customize the engine model to reduce residuals between the estimated and sensed outputs.

17. The system of claim 16, wherein the engine model comprises a physics based model, or an empirical model, or a steady state model, or a transient model, or combinations thereof.

18. The system of claim 16, wherein the control inputs comprise a fuel flow, or an active clearance control, or variable geometry, or power extraction, or combinations thereof for components of the engine.

19. The system of claim 18, wherein the components of the engine comprise a fan, or a booster, or a high-pressure compressor, or a low-pressure compressor, or a high-pressure turbine, or a low-pressure turbine, or a combustor.

20. The system of claim 16, wherein the sensed inputs comprise a temperature, or a pressure, or an altitude, or a Mach number, or combinations thereof.

21. The system of claim 16, wherein the outputs comprise a temperature, or a pressure, or a rotor speed, or efficiency, or a flow capacity, or an inter-component temperature, or combinations thereof.

22. The system of claim 16, wherein the estimator comprises a state estimator configured to determine a state of the engine.

23. The system of claim 16, wherein the estimator comprises a tracking filter configured to estimate parameters for the engine model based upon an observer for reducing the residuals.

24. The system of claim 23, wherein the tracking filter comprises an extended Kalman filter.

25. The system of claim 16, further comprising a fault diagnostics system configured to detect and isolate faults in the engine based upon the residuals between the estimated and sensed outputs and a set of faults or fault signatures via a multiple model hypothesis test.

26. The system of claim 16, further comprising a trending module configured to generate a trend of deterioration of the engine on a component-by-component basis based upon change in estimated parameters for the engine model.

27. A computer readable medium comprising one or more tangible media, wherein the one or more tangible media comprise:
code adapted to apply control inputs to an engine and an engine model;
code adapted to estimate outputs from the engine model based upon the control inputs;
code adapted to sense outputs from the engine;
code adapted to analyze residuals between estimated and sensed outputs;
code adapted to customize the engine model to reduce residuals for a particular engine; and
code adapted to detect and isolate faults in the engine based upon the residuals for the particular engine.

28. A system for detecting faults in a turbomachinery, comprising:
means for applying control inputs to the turbomachinery and a turbomachinery model;
means for estimating outputs from the turbomachinery model based upon control inputs;
means for sensing outputs from the turbomachinery;
means for analyzing residuals between the estimated and sensed outputs; and
means for customizing the model based upon the residuals between the estimated and sensed outputs.

29. The system of claim 28, further comprising means for detecting and isolating faults in the turbomachinery based upon residuals between the estimated and sensed outputs.

30. The system of claim 28, wherein the turbomachinery comprises an aircraft engine, or an industrial gas turbine, or steam turbine.
